(19) United States
(12) Patent Application Publication
(10) Pub. No.: US 2009/0071113 A1
(43) Pub. Date: Mar. 19, 2009

(54) FILTER ELEMENT

(75) Inventors: Toshinori Oba, Shizuoka (JP); Atsushi Suzuki, Shizuoka (JP)

Correspondence Address: YOUNG & THOMPSON, 209 Madison Street, Suite 500, ALEXANDRIA, VA, 22314, US

(73) Assignee: TOYO ROKI SEIZO KABUSHIKI KAISHA, Hamamatsu, Shizuoka (JP)

(21) Appl. No.: 11/914,388

(22) PCT Filed: Jun. 1, 2006
(86) PCT No.: PCT/JP2006/310962

§ 371 Date: Nov. 14, 2007

(30) Foreign Application Priority Data
Jun. 7, 2005 (JP) 2005-167282

(51) Int. Cl. B01D 50/00

(52) U.S. Cl. 55/486

(57) ABSTRACT

A filter element includes an upstream side layer structure disposed on an upstream side in a flow direction of air to be filtrated and formed of a non woven fabric formed by laminating chemical fibers, and a downstream side layer structure disposed on a downstream side in the flow direction of the air and including a plurality of layers including chemical fiber non woven fabric layers formed by laminating chemical fibers. The upstream side layer structure has a fiber density relatively smaller than that of the downstream side layer structure. The downstream side layer structure includes a natural fiber layer such as cotton layer disposed between the chemical fiber non fabric layers, and an oil is impregnated from the upstream side layer structure to the natural fiber layer in the downstream side layer structure.

### BACKGROUND OF THE INVENTION

1. Field of the Invention

The present invention relates to a filter element composed of a laminated non woven fabric and utilized for an air filter.

2. Related Art

An air cleaner is disposed in an intake system of an internal combustion engine so as to filtrate an air taken into the engine. The air cleaner includes a housing in which a filter element formed by laminating a plurality of filter papers and/or non woven fabrics. A non woven fabric formed of polyethylene telephthalate (PET) fiber may be generally widely used as the material constituting the laminated layers of the filter element.

In such air cleaner, the filter element is impregnated with an oil such as viscous oil for capturing dust contained in the taken air disclosed, for example, in Japanese Patent Application Unexamined (KOKAI) Publication No. 2003-299921.

However, it was found, according to an experiment of the inventor of the subject application, that it was difficult to retain the oil in the filter element formed by laminating the PET non woven fabric.

That is, the filter element formed by laminating the PET non woven fabric has less oil retaining performance, and according to this reason, when the air is filtrated by the air cleaner using such filter element, the oil impregnated at the downstream side of the air flow is scattered and passed from the filter element.

In the case where the oil is scattered and passed from the filter element, not only the dust capturing performance is deteriorated, but also the engine is contaminated.

An object of the present invention is to substantially eliminate defects or drawbacks encountered in the prior art mentioned above and to provide a filter element capable of preventing oil from scattering and passing through, and maintaining an initial dust capturing performance for a long time.

### SUMMARY OF THE INVENTION

This and other objects can be achieved according to the present invention by providing a filter element comprising:

an upstream side layer structure disposed on an upstream side in a flow direction of air to be filtrated and formed of a non woven fabric formed by laminating chemical fibers; and

a downstream side layer structure disposed on a downstream side in the flow direction of the air and including a plurality of layers including chemical fiber non woven fabric layers formed by laminating chemical fibers,

wherein the upstream side layer structure has a fiber density relatively smaller than that of the downstream side layer structure, the downstream side layer structure includes a natural fiber layer formed from a natural fiber disposed between the chemical fiber non fabric layers, and an oil is impregnated from the upstream side layer structure to the natural fiber layer in the downstream side layer structure.

In the above aspect, the downstream side layer structure may include at least two chemical fiber non woven fabric layers on the downstream side of the natural fiber layer.

It may be desired that the chemical fiber non woven fabric layer of the upstream side structure is a polyethylene telephthalate fiber layer and the chemical non woven fabric layers of the downstream side layer structures are polyethylene telephthalate fiber layers.

It is also desired that the filter element is impregnated with an oil of an amount of 0.5 g/100 cm² to 0.9 g/cm².

According to the present invention of the structures and characters mentioned above, since the oil capable of capturing the dust contained in the air is retained in the filter element, the dust can be effectively captured or trapped, and by retaining the oil in the filter element, the scattering or pass-through of the oil from the filter element can be preferably prevented, thus effectively filtrating the air. During this filtrating process, the air-flow resistance, the air cleaning efficiency and the dust capturing performance can be enhanced more than prescribed values.

The nature and further characteristic features of the present invention will be made more clear from the following descriptions made with reference to the accompanying drawings.

### BRIEF DESCRIPTION OF THE DRAWINGS

In the accompanying drawings:

FIG. 1 is an illustrated sectional view showing a lamination structure of a filter element of the present invention;

FIG. 2 is an illustrated sectional view showing a lamination structure of a filter element in which all the layers are formed of polyethylene telephthalate (PET) fiber;

FIG. 3 is a graph representing an air-flow resistance of the filter element shown in FIGS. 1 and 2;

FIG. 4 is a graph representing air-cleaning efficiency of the filter elements shown in FIGS. 1 and 2; and

FIG. 5 is a graph representing dust capturing (captured) amounts of the filter elements shown in FIGS. 1 and 2.

### DESCRIPTION OF THE PREFERRED EMBODIMENT

The present invention will be described hereunder with reference to the accompanying drawings.

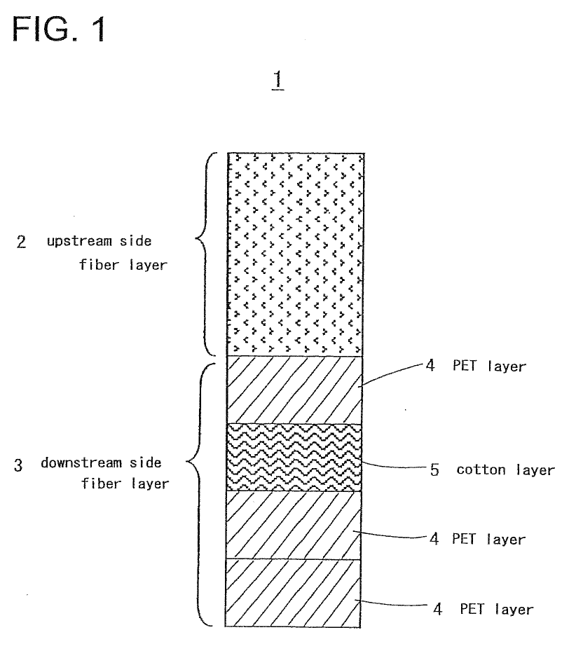

With reference to FIG. 1, showing the lamination structure of a filter element 1 according to the present invention, the filter element 1 is formed of an upstream side fabric layer (called upstream side layer 2 hereinafter) and a downstream side fabric layer (called downstream side layer 3 hereinafter). In this filter element 1, air flows form the upstream side layer 2 to the downstream side layer 3, and during this flow in the filter element 1, the air can be filtrated.

The upstream side layer 2 is formed by a needle-punch method effected to a polyethylene telephthalate (PET) fiber as a single layer of non woven fabric having a constant thickness. Further, the upstream side layer 2 may be formed by a dry method such as a stitch-bond method, chemical-bond method or thermal-bond method other than the needle-punch method. On the other hand, the downstream side layer 3 is formed so as to provide a four-layered structure including three PET layers 4 and one cotton layer 5 as natural fiber layer. The respective PET layers 4 and the cotton layer 5 are formed from a non woven fabric laminated by a water-jet method. Further, in the following descriptions, an example in which the natural fiber layer is the cotton layer is explained, but another natural fiber such as wool, pulp or linter may be also utilized.

In the filter element of this embodiment, the downstream side layer 3 includes the cotton layer 5 between one PRT layer 4 on the upstream side and two PET layer 4 on the downstream side. Further, the upstream side layer 2 has a rough fiber density relatively more than that of the downstream side layer 3.

The diameter of each of the fibers constituting the filter element 1 and METSUKE amount (fiber amount per unit area) thereof may be determined as follows.

The upstream side layer 2 is composed of non woven fabric of PET fiber having a fiber diameter of 2.0 to 10.0 denier (14.3 to 32.0 μm), and the METSUKE amount of 50 to 300 g/m². On the other hand, the downstream side layer 3 is composed of non woven fabric of PET fiber having a fiber diameter of 0.5 to 3 denier (7.2 to 17.5 μm), and the METSUKE amount of 20 to 100 g/m². Further, the cotton layer 5 of the downstream side layer 3 is composed of cotton fiber having a fiber diameter of 1.0 to 1.3 denier (9.0 to 11.0 μm), and the METSUKE amount of 20 to 100 g/m². The total thickness of the downstream side layer 3 composed of these layers is of 1.0 to 3.0 mm.

The filter element 1 is impregnated with an oil from the upstream side of the filter element 1. The oil impregnated from the upstream side impregnates the upstream side layer 2 and one PET layer of the downstream side layer 3 (upstream side of the cotton layer 5) and the cotton layer 5 thereof. A viscous oil may be utilized as such oil, which is generally utilized for capturing dust, and the amount of oil to be impregnated may be 0.5/100 cm²-0.9/100 cm² per unit area. Further, the optimum amount including this oil differs according to the shapes of the air cleaners, and for this reason, the optimum amount will differ by set aimed values of air-flow resistance, cleaning efficiency and carbon dust capturing (captured) amount. Accordingly, it is not strictly prohibited for the oil amount to be less than 0.5/100 cm² and more than 0.9/100 cm².

In such filter element 1 of the structure mentioned above, the cotton layer 5 prevents the oil from scattering downstream side and passing through the layer, thus serving as a oil retaining member for retaining the oil to the filter element 1. The PET fiber constituting the PET layer 4 has a substantially circular cross-sectional shape and a smooth outer surface. For this reason, less friction is caused between the PET layer 4 and the oil, and hence, the oil is likely scattered and passed through. On the other hand, the cotton layer 5 has a flat cross-sectional shape and the diameters of the fibers constituting the cotton layer 5 are not uniform. In addition, the cotton layer 5 has a rough outer surface. For this reason, relatively large friction is caused between the cotton fiber and the oil, and hence, the oil is likely entangled with the cotton fiber to thereby prevent the oil from scattering and passing therefrom.

As mentioned above, according to the filter element of this embodiment, the oil impregnated in the cotton layer 5 and the PET layer upstream side the cotton layer is retained by the cotton layer, thus effectively maintaining the dust capturing performance for a long time. Further, the dust mentioned herein includes carbon particle as well as so-called dust in air.

Further, although in the described embodiment, the layer structure of the downstream side layer 3 constitutes, from the upstream side thereof, PET layer 4/cotton layer 5/PET layer 4/PET layer 4, the present invention is not limited to such layer structure.

A chemical fiber non woven fabric formed by laminating chemical fibers by the water-jet method has generally thin thickness, and therefore, in a case where only one PET layer 4 is disposed on the downstream side of the cotton layer 5, there is a fear of scattering or passing through the impregnated oil. In order to avoid such defect, it is necessary to dispose at least two PET layers 4 on the downstream side of the cotton layer 5. On the contrary, the increased thickness of the filter element 1 will increase the flow resistance.

In view of this matter, in an alternation of the two PET layer 4 on the downstream side of the cotton layer 5, three or more PET layers 4 may be disposed as long as the flow resistance does not so big and air can relatively properly passes.

In addition, the PET layer 4 disposed on the upstream side of the cotton layer 5 is also not limited to one layer, and two or more PET layers 4 may be disposed as long as the flow resistance does not so big and air can relatively properly passes.

Furthermore, the present invention is not limited to the example of the filter element 1 shown in FIG. 1 in which the chemical fiber layers of the filter element 1 in the upstream side layer 2 and downstream side layer 3 are formed from non woven fabric of the PET layers 4.

As the chemical fiber, in place of the PET fiber, there may be used synthetic fiber (for example, polyolefin group fiber (such as poly C₂₋₄ olefin group fiber including polyethylene group fiber and polypropylene group fiber), acryl group fiber, polyester group fiber (polyalkylene telephthalate group fiber such as polybutylene telephthalate (PBT), total-aromatic polyester group fiber, or like), or polyamide fiber (including aromatic polyamide fiber such as alamide fiber) or rayon fiber). Further, two or more than two fibers of the above fibers, including PET fiber, may be also used in combination.

### EXPERIMENTAL EXAMPLE

A test was carried out to confirm what extent of oil retaining performance is possessed by the filter element including the cotton layer 5 of the embodiment of the present invention. The test was a carbon dust capturing test in which air containing carbon dust passed through the filter element 1 having the layer structure of FIG. 1. The following Table 1 indicates the details of the filter element 1 utilized for the test.

TABLE 1

| | | | | METSUKE | Total |
|---|---|---|---|---|---|
| | Sub- | Fiber Diameter | | Amount | Thickness |
| Layer | stance | (denier ) | (μm) | (g/m²) | (mm) |
| Upstream | PET | 3.0/6.0 | 17.5/24.8 | 70 | 1.6 |
| Layer | | | | | |
| Downstream | PET | 0.8/1.4 | 9.1/12.0 | 30 | |
| Layer | Cotton | 1.0-1.3 | 9.0-11.0 | 35 | |
| | PET | 0.8/1.4 | 9.1/12.0 | 30 | |
| | PET | 0.8/1.4 | 9.1/12.0 | 30 | |

A plurality of sample products of the filter element 1 according to the present invention, in which amount of oil to be impregnated in the filter element per 100 cm² varied, were prepared, and air was passed these sample products, and three characteristic features of air-flow resistance, cleaning efficiency and carbon dust capturing property were then measured.

Herein, the air-flow resistance is a resisting pressure at a time when the introduced air initially passes the filter element. The cleaning efficiency is indicated with a ratio of dust capture amount of the filter element 1 (capture amount) with respect to the projected carbon dust amount (project amount) at a time when the air passes at a constant flow ratio of spec. (value preliminarily set in the conference between the manufacturer and user), that is, the ratio of (capture amount)/(project amount) (%). The carbon dust capturing (captured) amount is a value “gram” of the carbon dust projected into the filter element 1 up to a specified pressure.

Further, for the sake of reference, another filter element 1a, which is formed from all PET layers 4 including no cotton layer 5, was prepared and compared with the filter element 1 including the cotton layer 5 with respect to the impregnated oil amount.

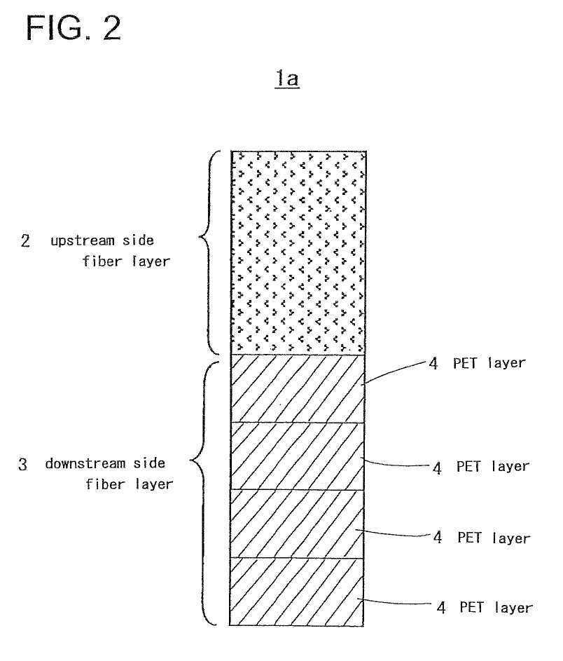

FIG. 2 shows the filter element 1a having a layer structure including all PET layers 4. Further, the filter element 1a has specification including the same thickness, density and so on as those of the filter element 1 including the cotton layer 5.

The following Tables 2 and 3 show how much oil was impregnated for the respective sample products with respect to the filter elements 1 including the cotton layer and including all the PET layers 4 (no cotton layer 5), respectively.

TABLE 2
(Filter Element Including Cotton Layer)

| | | | Dust | | |
|---|---|---|---|---|---|
| | Air-flow | Cleaning | capturing | Impregnated | |
| | Resistance | Efficiency | amount | Oil Amount | |
| Sample | (kPa) | (%) | (g) | (g) | Remarks |
| 0.4 | 1.81 | 83.43 | 3.02 | 15 | |
| 0.5 | 1.81 | 83.50 | 5.31 | 19 | |
| 0.6 | 1.81 | 83.04 | 6.20 | 23 | |
| 0.7 | 1.82 | 82.96 | 6.38 | 26 | |
| 0.8 | 1.82 | 81.18 | 6.40 | 30 | |
| 0.9 | 1.83 | 80.09 | 6.99 | 34 | |
| 1.0 | 1.84 | 75.64 | 7.26 | 38 | Oil |
| | | | | | Pass-through |
| Aimed | — | 80.0≦ | 4.7≦ | — | — |
| Value | | | | | |

TABLE 3
(Filter Element Including All PET Layers)

| | | | Dust | | |
|---|---|---|---|---|---|
| | Air-flow | Cleaning | capturing | Impregnated | |
| | Resistance | Efficiency | amount | Oil Amount | |
| Sample | (kPa) | (%) | (g) | (g) | Remarks |
| 0.5 | 1.79 | 81.94 | 4.16 | 19 | |
| 0.6 | 1.80 | 81.10 | 4.78 | 23 | |
| 0.7 | 1.78 | 81.14 | 5.05 | 26 | Oil |
| | | | | | Pass-through |
| 0.8 | 1.79 | 80.00 | 5.40 | 30 | Oil |
| | | | | | Pass-through |
| Aimed | — | 80.0≦ | 4.7≦ | — | — |
| Value | | | | | |

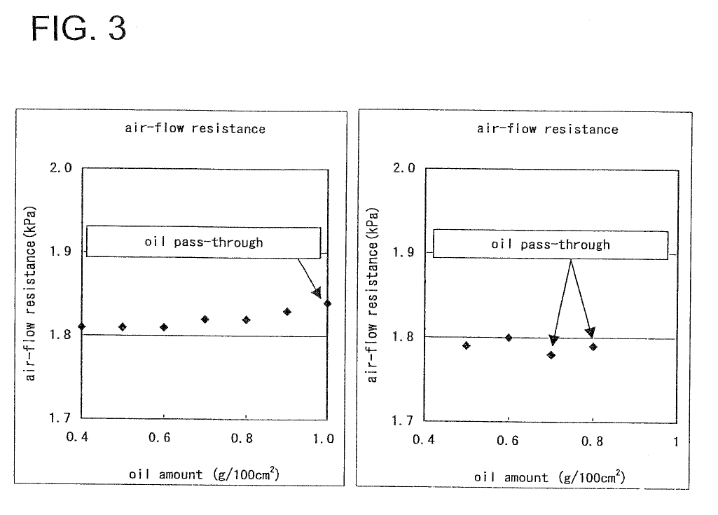

FIGS. 3-5 are graphs showing test results, in which the left side views are graphs representing data concerning the filter element 1 including the cotton layer 5 and the right side views are graphs representing data concerning the filter element 1a including no cotton layer.

With reference to FIG. 3, for the filter element 1 including the cotton layer 5, the air-flow resistance gradually increases such as 1.81 kPa to 1.84 kPa in accordance with the increasing of the oil amount. That is, the air-flow resistance increases in proportion to the increasing amount of the oil.

In the visual inspection of the filter elements 1, it was confirmed that the oil leaked (passed through) from the rear surface for the sample products having the oil impregnating amounts of 1.0 g/100 cm².

For this, about the filter elements 1a including no cotton layer, in the right view of FIG. 3, it was not confirmed that the oil scattered or passed through for the sample products having the oil impregnating amounts of 0.5 g/100 cm² and 0.6 g/100 cm². For this, it was confirmed that the oil scattered or passed through for the sample products having the oil impregnating amounts of 0.7 g/100 cm² and 0.8 g/100 cm², in such the sample products, it could not achieve an original purpose to prevent the filter elements that was not confirmed the oil scattering or passing through.

In the visual inspection, it was confirmed that the oil leaked (passed through) from the rear surface of the filter elements 1a for the sample products having the oil impregnating amounts of 0.7 g/100 cm² and 0.8 g/100 cm².

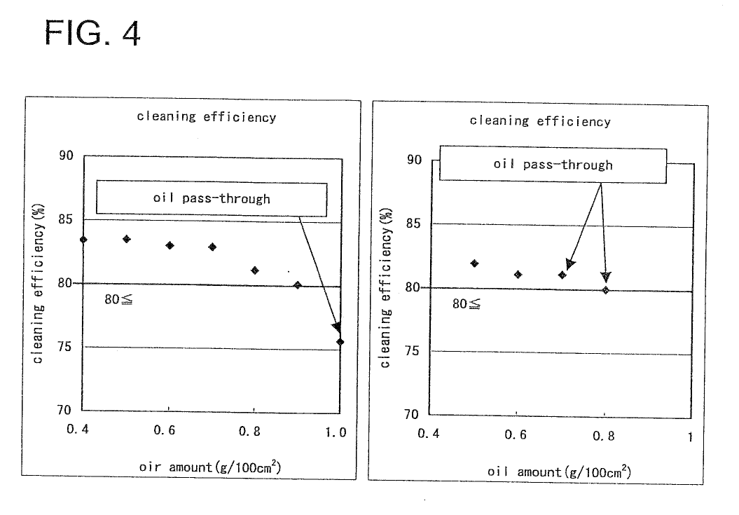

Next, with reference to FIG. 4, it is generally aimed for the air cleaner that the carbon dust cleaning efficiency of 80% is realized. In this view point, as shown in the left side graph in FIG. 4, in the filter element 1 including the cotton layer 5, a sample product having the oil impregnating amount of 0.5 g/100 cm² to 0.8 g/100 cm² provided the cleaning efficiency of almost more than 80%. However, in a sample product having the oil impregnating amount of 0.4 g/100 cm², the cleaning efficiency was 79.4% which was less than 80%. Moreover, in sample products having the oil impregnating amounts of 0.9 g/100 cm² and 1.0 g/100 cm², the cleaning efficiencies were 78.6% and 75.6%, which were less than 80%. Further, concerning the oil scattering and pass-through phenomena, as mentioned above, the oil bleeding from the rear surface of the filter element was confirmed only with respect to the case of the sample product having the oil impregnating amount of 1.0 g/100 cm².

On the other hand, as shown on the right side graph in FIG. 4, in the filter element 1a including only the PET layers 4 and no cotton layer 5, a sample product having the oil impregnating amount of 0.5 g/100 cm² to 0.8 g/100 cm² provided the cleaning efficiency of more than 80%. However, the cleaning efficiency was decreased as the oil amount to be impregnated was increased. Further, a sample product having the oil impregnating amount of 0.8 g/100 cm², the cleaning efficiency was decreased almost to 80%. In the filter element 1a including only the PET layers 4, in the case that the oil impregnating amount was 0.7 g/100 cm², the oil was scattered and passed through, and according to such fact, the practically usable range will be limited to be less than 0.6 g/100 cm².

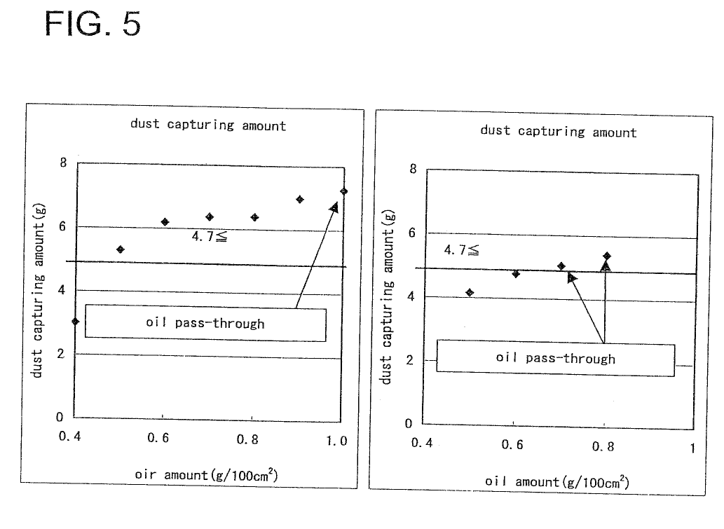

With reference to FIG. 5, an aimed value of the carbon dust amount to be captured is more than 4.7 g.

In the filter element 1 including the cotton layer 5 shown in the left side graph in FIG. 5, a value of carbon dust amount to be captured of more than 4.7 g was obtained for a sample product having the oil impregnating amount of more than 0.5 g/100 cm². However, for the sample product having the impregnating amount of 0.4 g/100 cm², a value less than 3.0 g and 4.7 g was only obtained.

On the other hand, in the filter element 1a including only the PET layers 4, a sample produce having the oil impregnating amount of 0.6 g/100 cm² showed a carbon dust capture amount of over 4.7 g, and a sample product having the oil impregnating amount of 0.5 g/cm² showed the carbon dust capturing values of less than 4.1 g and 4.7 g. Further, in view of the carbon dust capturing amount, for the filter element 1a including only the PET layers 4, it may be better to have the oil impregnating amount of more than 0.6 g/cm². However, for sample products having oil impregnating amounts of 0.7 g/100 cm² and 0.8 g/100 cm², the oil scattering and oil pass-through phenomena were observed, thus being considered to be not practical for use.

From the test results mentioned above, it will be found that it is better for the filter element 1 including the cotton layer 5 to be impregnated with the oil impregnating amount in a range of 0.5 g/100 cm² to 0.9 g/100 cm².

It is further to be noted that the present invention is not limited to the described embodiment and many other changes and modifications may be made without departing from the scopes of the appended claims.

What is claimed is:

1 A filter element comprising:
an upstream side layer structure disposed on an upstream side in a flow direction of air to be filtrated and formed of a non woven fabric formed by laminating chemical fibers; and
a downstream side layer structure disposed on a downstream side in the flow direction of the air and including a plurality of layers including chemical fiber non woven fabric layers formed by laminating chemical fibers,
wherein the upstream side layer structure has a fiber density relatively smaller than that of the downstream side layer structure, the downstream side layer structure includes a natural fiber layer formed from a natural fiber disposed between the chemical fiber non fabric layers, and an oil is impregnated from the upstream side layer structure to the natural fiber layer in the downstream side layer structure.

2. The filter element according to claim 1, wherein the downstream side layer structure includes at least two chemical fiber non woven fabric layers on the downstream side of the natural fiber layer.

3. The filter element according to claim 1, wherein the chemical fiber non woven fabric layer of the upstream side structure is a polyethylene telephthalate fiber layer and the chemical non woven fabric layers of the downstream side layer structures are polyethylene telephthalate fiber layers.

4. The filter element according to claim 1, wherein the filter element is impregnated with an oil of an amount of 0.5 g/100 cm² to 0.9 g/cm².
